(19) United States
(12) Patent Application Publication
(10) Pub. No.: US 2014/0045022 A1
(43) Pub. Date: Feb. 13, 2014

(54) NONAQUEOUS ELECTROLYTE SECONDARY BATTERY

(71) Applicant: SANYO Electric Co., Ltd., Osaka (JP)

(72) Inventors: Tetsuya Matsuda, Kasai-shi (JP); Toyoki Fujihara, Kanzaki-gun (JP); Toshiyuki Nohma, Kakogawa-shi (JP)

(73) Assignee: SANYO ELECTRIC CO., LTD., Osaka (JP)

(21) Appl. No.: 13/962,256

(22) Filed: Aug. 8, 2013

(30) Foreign Application Priority Data
Aug. 9, 2012 (JP) 2012-177251

(51) Int. Cl. H01M 10/04

(52) U.S. Cl. CPC H01M 10/0431
USPC 429/94

(57) ABSTRACT

In a prismatic nonaqueous electrolyte secondary battery, a flat winding electrode assembly and a nonaqueous electrolyte are housed in a prismatic outer body. A positive electrode includes a positive electrode substrate exposed portion formed along the longitudinal direction. A negative electrode includes a negative electrode substrate exposed portion formed along the longitudinal direction. The nonaqueous electrolyte contains a lithium salt having an oxalate complex as an anion at the time of making the nonaqueous electrolyte secondary battery. The area of the negative electrode substrate exposed portion is 700 cm² or more. The area of the positive electrode substrate exposed portion is 500 cm² or more. The area of the negative electrode substrate exposed portion is larger than the area of the positive electrode substrate exposed portion. The prismatic nonaqueous electrolyte secondary battery above can provide a nonaqueous electrolyte secondary battery that has excellent cycling characteristics and excellent reliability.

### TECHNICAL FIELD

The present invention relates to a nonaqueous electrolyte secondary battery that has excellent cycling characteristics and excellent reliability.

### BACKGROUND ART

Alkaline secondary batteries typified by nickel-hydrogen batteries and nonaqueous electrolyte secondary batteries typified by lithium ion batteries have been widely used as a power supply for driving portable electronic equipment, such as cell phones including smartphones, portable personal computers, PDAs, and portable music players. In addition, alkaline secondary batteries and nonaqueous electrolyte secondary batteries have been widely used as a power supply for driving electric vehicles (EVs) and hybrid electric vehicles (HEVs and PHEVs), and in stationary storage battery systems for suppressing output fluctuation of solar power generation and wind power generation, for example, and for a peak shift of system power that utilizes the power during the daytime while saving the power during the nighttime.

The use of EVs, HEVs, and PHEVs or the stationary storage battery system especially requires high capacity and high output characteristics. The size of each battery is therefore increased, and a plurality of batteries are connected in series or in parallel for use. Therefore, nonaqueous electrolyte secondary batteries have been generally used for these purposes in view of space efficiency. When physical strength is needed, a metal prismatic outer body with one side open, and a metal sealing plate for sealing this opening are generally adopted as an outer body of a battery.

Increasing longevity is essential in nonaqueous electrolyte secondary batteries used for the above-mentioned purposes. Therefore, various additives are added to a nonaqueous electrolyte in order to prevent degradation. For example, JP-A-2009-129541 discloses that, in a nonaqueous electrolyte secondary battery, a cyclic phosphazene compound and a salt having various oxalate complexes as an anion are added to a nonaqueous electrolyte. JP-T-2010-531856 and JP-A-2010-108624 describe adding lithium bis(oxalato)borate (Li[B(C₂O₄)₂], hereinafter referred to as “LiBOB”), which is a lithium salt having an oxalate complex as an anion, as represented by the following structural formula (I).

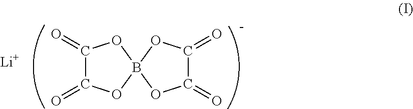

Japanese Patent No. 3439085 discloses the invention of a nonaqueous electrolyte secondary battery in which lithium difluorophosphate (LiPF₂O₂) is added to a nonaqueous electrolyte in order to prevent self-discharge at charge storage and improve storage characteristics after charging. JP-A-2007-227367 shows an example in which LiPF₂O₂ is added to a nonaqueous electrolyte in order to obtain a nonaqueous electrolyte secondary battery having excellent cycling characteristics and low-temperature outputs.

When a cyclic phosphazene compound and a salt having various oxalate complexes as an anion disclosed in JP-A-2009-129541 are added to a nonaqueous electrolyte, fire resistance of the nonaqueous electrolyte is improved, which can provide a nonaqueous electrolyte secondary battery having excellent battery characteristics and high safety. When LiBOB disclosed in JP-T-2010-531856 and JP-A-2010-108624 is added to a nonaqueous electrolyte, a protective layer including a lithium ion conductive layer that is thin and extremely stable is formed on the surface of a carbon negative electrode active material of the nonaqueous electrolyte secondary battery. This protective layer is stable even in a high temperature, consequently preventing the carbon negative electrode active material from decomposing the nonaqueous electrolyte. This leads to an advantage of providing excellent cycling characteristics and improving the safety of a battery.

In the nonaqueous electrolyte secondary battery disclosed in Japanese Patent No. 3439085, LiPF₂O₂ and lithium react to form a high-quality protective covering on the surfaces of a positive electrode and a negative electrode. This protective covering prevents direct contact between an active material in a state of charge and an organic solvent, thereby preventing decomposition of a nonaqueous electrolyte due to the contact between the active material and the nonaqueous electrolyte and improving charge storage characteristics. In the nonaqueous electrolyte secondary battery disclosed in JP-A-2007-227367, a protective covering formed by LiPF₂O₂ brings preferable cycling characteristics, and leads to an advantage of providing a nonaqueous electrolyte secondary battery having excellent low-temperature characteristics.

In a nonaqueous electrolyte secondary battery using a nonaqueous electrolyte in which a lithium salt having an oxalate complex as an anion is added to a nonaqueous solvent, a problem has been found that, when a battery is in an abnormal condition due to being crushed, for example, and the temperature thereof increased, the reaction is likely to proceed between a negative electrode formed with a protective covering and the nonaqueous electrolyte. This increases the amount of heat generation of the battery. A nonaqueous electrolyte secondary battery requiring high capacity and high output characteristics requires large absolute amounts of a negative electrode mixture and a lithium salt having an oxalate complex as an anion, which are responsible for the heat reaction.

### SUMMARY

An advantage of some aspects of the invention is to provide a nonaqueous electrolyte secondary battery that has excellent cycling characteristics and excellent reliability.

A nonaqueous electrolyte secondary battery according to an aspect of the invention includes: a flat winding electrode assembly formed by winding an elongated positive electrode and an elongated negative electrode with an elongated separator interposed therebetween; and a prismatic outer body storing the flat winding electrode assembly and a nonaqueous electrolyte. The positive electrode includes a positive electrode substrate exposed portion formed along a longitudinal direction. The negative electrode includes a negative electrode substrate exposed portion formed along a longitudinal direction. The nonaqueous electrolyte contains a lithium salt having an oxalate complex as an anion at the time of making the nonaqueous electrolyte secondary battery. The area of the negative electrode substrate exposed portion is 700 cm² or more. The area of the positive electrode substrate exposed portion is 500 cm² or more. The area of the negative electrode substrate exposed portion is larger than the area of the positive electrode substrate exposed portion.

When the lithium salt having the oxalate complex as an anion is added to the nonaqueous electrolyte, a protective covering formed due to a reaction between the lithium salt having the oxalate complex as an anion and a negative electrode active material is formed on the surface of the negative electrode, which brings preferable cycling characteristics. However, when the temperature of the battery increases, a reaction is likely to proceed between the negative electrode with the protective covering derived from the lithium salt formed with the oxalate complex as an anion and the nonaqueous electrolyte. This increases the amount of heat generation of the battery. In the nonaqueous electrolyte secondary battery of the invention, the area of the negative electrode substrate exposed portion is 700 cm² or more, and the area of the positive electrode substrate exposed portion is 500 cm² or more, thereby improving heat release characteristics from the inside of the electrode assembly, preventing an increase in temperature of the negative electrode, and preventing a reaction between the negative electrode where the protective covering is formed and the nonaqueous electrolyte. Furthermore, the area of the negative electrode substrate exposed portion is larger than the area of the positive electrode substrate exposed portion, thereby preventing an increase in temperature of the negative electrode and preventing a reaction between the negative electrode where the protective covering is formed and the nonaqueous electrolyte more efficiently.

In the invention, when the substrate exposed portions are formed onto both sides of the electrode, the area of the substrate exposed portion is the sum of the areas of the substrate exposed portions formed onto both sides of the electrode. In such a case, the areas of the substrate exposed portions formed onto both sides of the electrode may be different in one side and the other side.

A nonaqueous electrolyte secondary battery having a large capacity increases the absolute amounts of the negative electrode active material and the lithium salt having the oxalate complex as an anion, which are responsible for a heat reaction, and also increases the amount of heat generation. However, in the nonaqueous electrolyte secondary battery of the invention, the temperature of the negative electrode is unlikely to increase, thereby preventing a reaction between the negative electrode where the protective covering is formed and the nonaqueous electrolyte. Consequently, with the nonaqueous electrolyte secondary battery of the invention, a nonaqueous electrolyte secondary battery can be provided that has high cycling characteristics and improved reliability.

A compound capable of reversibly absorbing and desorbing lithium ions may be selected to be used as appropriate as the positive electrode active material that can be used in the nonaqueous electrolyte secondary battery of the invention. Such electrode active materials include lithium transition-metal composite oxides that are represented by LiMO₂ (M is at least one of Co, Ni, and Mn) and are capable of reversibly absorbing and desorbing lithium ions, namely, LiCoO₂, LiNiO₂, LiNi_{y}Co_{1-y}O₂ (y=0.01 to 0.99), LiMnO₂, LiCoₓMn_{y}Ni_{z}O₂ (x+y+z=1), LiMn₂O₄, or LiFePo₄. Such lithium transition-metal composite oxides may be used alone, or two or more of them may be mixed to be used. Furthermore, lithium cobalt composite oxides with different metal element such as zirconium, magnesium, and aluminum added thereto may be used as well.

The following shows examples of a nonaqueous solvent that can be used for the nonaqueous electrolyte in the nonaqueous electrolyte secondary battery of the invention: a cyclic carbonate such as ethylene carbonate (EC), propylene carbonate (PC), and butylene carbonate (BC); a fluorinated cyclic carbonate: a cyclic carboxylic ester such as γ-butyrolactone (γ-BL) and γ-valerolactone (γ-VL); a chain carbonate such as dimethyl carbonate (DMC), ethyl methyl carbonate (EMC), diethyl carbonate (DEC), methylpropyl carbonate (MPC), and dibutyl carbonate (DBC); fluorinated chain carbonate: a chain carboxylic ester such as methyl pivalate, ethyl pivalate, methyl isobutyrate, and methyl propionate; an amide compound such as N,N′-dimethylformamide and N-methyl oxazolidinone; and a sulfur compound such as sulfolane. It is desirable that two or more of them be mixed to be used.

In the nonaqueous electrolyte secondary battery of the invention, the lithium salt that is commonly used as an electrolyte salt for an nonaqueous electrolyte secondary battery may be used as the electrolyte salt dissolved in the nonaqueous solvent. Examples of such a lithium salt are as follows: LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures of these substances. In particular, among them, it is preferable that LiPF₆ (lithium hexafluorophosphate) be used. The amount of dissolution of the electrolyte salt with respect to the nonaqueous solvent is preferably from 0.8 to 1.5 mol/L.

In the nonaqueous electrolyte secondary battery of the invention, the lithium salt having the oxalate complex as an anion is preferably contained in the nonaqueous electrolyte in an amount of from 0.01 to 2.0 mol/L, more preferably from 0.05 to 0.2 mol/L at the time of making the nonaqueous electrolyte secondary battery. In the nonaqueous electrolyte secondary battery of the invention, the additive amount of the lithium salt having the oxalate complex in the nonaqueous electrolyte as an anion may be added as the electrolyte salt whose principal element is the lithium salt having the oxalate complex as an anion. However, a large additive amount of the lithium salt having the oxalate complex in the nonaqueous electrolyte as an anion increases the viscosity of the nonaqueous electrolyte. Therefore, various electrolyte salts as above may be used as principal elements, and the lithium salt having the oxalate complex as an anion may be added as an additive substance in a small amount, for example, about 0.1 mol/L. When the lithium salt having the oxalate complex as an anion is added as the additive substance, depending on the additive amount thereof, all of the lithium salt having the oxalate complex as an anion is consumed for forming the protective covering at the initial charge. This might lead to a case in which no lithium salt having the oxalate complex as an anion is substantially in the nonaqueous electrolyte. The invention also includes this case. Thus, the invention includes any case in which the nonaqueous electrolyte of the nonaqueous electrolyte secondary battery before the initial charge contains the lithium salt having the oxalate complex as an anion.

In the nonaqueous electrolyte secondary battery of the invention, it is preferable that the area of the negative electrode substrate exposed portion be 5 to 30% of the area of negative electrode active material mixture layers formed onto both sides of the negative electrode, and that the area of the positive electrode substrate exposed portion be 5 to 20% of the area of positive electrode active material mixture layers formed onto both sides of the positive electrode.

Such a structure enables even a nonaqueous electrolyte secondary battery having high capacity and high output characteristics to ensure the battery capacity per unit area and to have better heat release efficiency of the negative electrode. In the invention, when the active material mixture layers are formed onto both sides of the electrode, the area of the active material mixture layer is the sum of the areas of the active material mixture layers formed onto both sides of the electrode. In such a case, the areas of the active material mixture layers formed onto both sides of the electrode may be different in one side and the other side.

In the nonaqueous electrolyte secondary battery of the invention, it is preferable that the flat winding electrode assembly include the positive electrode substrate exposed portion wound on one end and the negative electrode substrate exposed portion wound on the other end. It is preferable that both outer faces of the positive electrode substrate exposed portion be welded and connected to a positive electrode collector, and both outer faces of the negative electrode substrate exposed portion be welded and connected to a negative electrode collector.

Such a structure enables heat generated inside the electrode assembly to be released easier from the wound substrate exposed portions to the outside of the electrode assembly. This structure also enables the heat generated inside the electrode assembly to be released to the outside of the electrode assembly through the collector welded and connected to both outer faces of the wound substrate exposed portions.

In the nonaqueous electrolyte secondary battery of the invention, it is preferable that the negative electrode substrate exposed portion be formed on both ends of the negative electrode in a width direction along the longitudinal direction. In such a case, it is preferable that one of the negative electrode substrate exposed portions be wider than the other, and the wider substrate exposed portion be connected to the negative electrode collector. In these cases, it is more preferable that the positive electrode substrate exposed portion be formed only on one side of the positive electrode in a width direction along the longitudinal direction.

Such a structure enables heat to be released from both ends of the negative electrode substrate exposed portions in the width direction, thereby further improving heat release from the negative electrode.

In the nonaqueous electrolyte secondary battery of the invention, it is preferable that the battery capacity be 4 Ah or more, more preferably 20 Ah or more.

A large battery capacity such as of 4 Ah or more increases the absolute amounts of the negative electrode active material and the lithium salt having the oxalate complex as an anion, which are responsible for a heat reaction, and also increases the amount of heat generation. Therefore, the above-mentioned effects of the invention can be successfully attained. In particular, the battery capacity being 20 Ah or further increases heat generation due to a reaction between the negative electrode where the protective covering is formed and the nonaqueous electrolyte. Therefore, the above-mentioned effect of the invention can be successfully attained.

It is preferable that the nonaqueous electrolyte of the invention contains lithium difluorophosphate (LiPF₂O₂) at the time of making the nonaqueous electrolyte secondary battery.

In the nonaqueous electrolyte secondary battery of the invention, the heat release characteristics are improved while a temperature inside the electrode assembly is likely to be low in a low-temperature environment. However, using the nonaqueous electrolyte including LiPF₂O₂ to form the nonaqueous electrolyte secondary battery enables the nonaqueous electrolyte secondary battery to have excellent output characteristics even in the low-temperature environment.

Depending on the added amount of LiPF₂O₂, all of LiPF₂O₂ are consumed for forming a protective covering at the initial charge and discharge. This might lead to a case in which no LiPF₂O₂ is substantially in the nonaqueous electrolyte. The invention also includes this case. Thus, the invention includes any case in which the nonaqueous electrolyte of the nonaqueous electrolyte secondary battery before the initial charge contains LiPF₂O₂. LiPF₂O₂ is preferably contained in an amount of from 0.01 to 2.0 mol/L, more preferably from 0.01 to 0.1 mol/L at the time of making the nonaqueous electrolyte secondary battery.

In the nonaqueous electrolyte secondary battery of the invention, it is preferable that the lithium salt having the oxalate complex as an anion be lithium bis(oxalato)borate (Li[B(C₂O₄)₂], hereinafter referred to as “LiBOB”).

Using LiBOB as the lithium salt having the oxalate complex as an anion provides the nonaqueous electrolyte secondary battery capable of attaining further preferable cycling characteristics. LiBOB is preferably contained in an amount of 0.01 to 2.0 mol/L, more preferably 0.05 to 0.2 mol/L, at the time of making the nonaqueous electrolyte secondary battery.

### BRIEF DESCRIPTION OF THE DRAWINGS

The invention will be described with reference to the accompanying drawings, wherein like numbers reference like elements.

FIG. 1A is a plan view of a prismatic nonaqueous electrolyte secondary battery in accordance with an embodiment. FIG. 1B is a front view thereof.

FIG. 2A is a fragmentary sectional view along line IIA-IIA of FIG. 1A. FIG. 2B is a fragmentary sectional view along line IIB-IIB of FIG. 2A. FIG. 2C is a sectional view along line IIC-IIC of FIG. 2A.

FIG. 3A is a plan view of a positive electrode used in the prismatic nonaqueous electrolyte secondary battery in accordance with the embodiment. FIG. 3B is a plan view of a negative electrode thereof.

FIG. 4 is a fragmentary enlarged sectional view along line IV-IV of FIG. 28.

FIG. 5 is a plan view of a negative electrode used in a prismatic nonaqueous electrolyte secondary battery in accordance with a first modification.

FIG. 6A is a fragmentary sectional view of a prismatic nonaqueous electrolyte secondary battery in accordance with a second modification, corresponding to FIG. 2A.

FIG. 6B is a sectional view along line VIB-VIB of FIG. 6A.

### DESCRIPTION OF EXEMPLARY EMBODIMENTS

An embodiment of the invention will be described below in detail with reference to the accompanying drawings. However, the embodiment described below is merely an illustrative example for understanding the technical spirit of the invention and are not intended to limit the invention to the embodiment. The invention may be equally applied to various modifications without departing from the technical spirit described in the claims.

### Embodiment

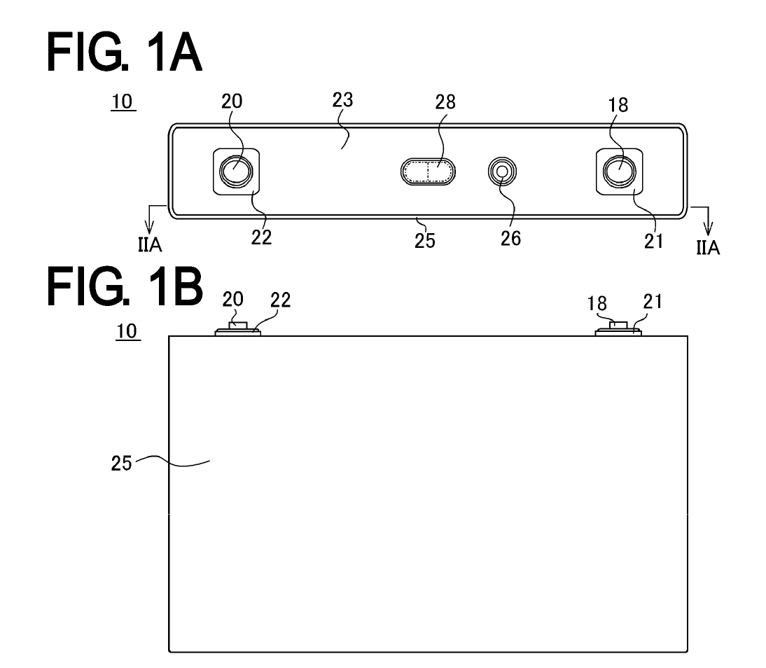

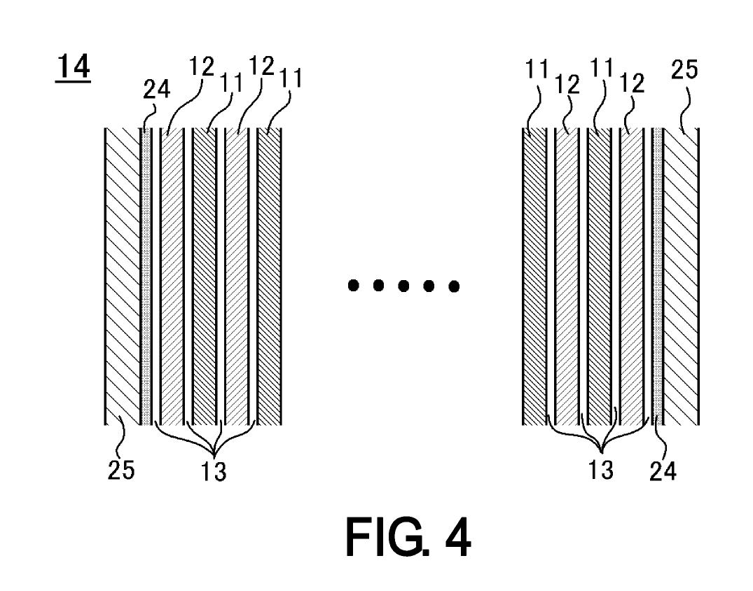

First, a prismatic nonaqueous electrolyte secondary battery in accordance with an embodiment will be described with reference to FIGS. 1 to 4. As shown in FIG. 4, this nonaqueous electrolyte secondary battery 10 includes a flattened winding electrode assembly 14. In the electrode assembly 14, a positive electrode 11 and a negative electrode 12 are wound while being insulated from each other with a separator 13 interposed therebetween. The winding electrode assembly 14 has its outermost side covered with the separator 13 and has the negative electrode 12 disposed on a further outer side than the positive electrode 11.

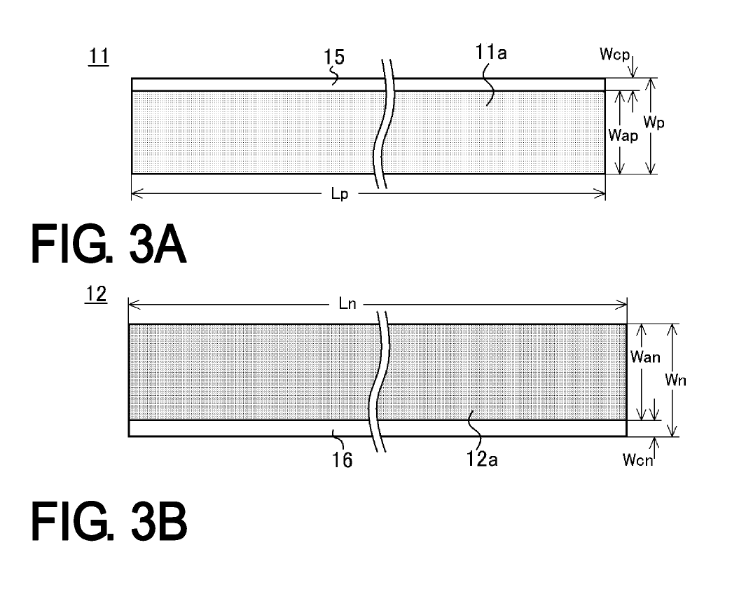

As shown in FIG. 3A, a positive electrode 11 is produced by the following process: a positive electrode active material mixture is applied onto both sides of a positive electrode substrate of aluminum foil: the resultant object is dried and extended by applying pressure; and the positive electrode 11 is slit so as to expose the aluminum foil in a strip along the end of one side in the wide direction. The part of the aluminum foil exposed in a strip is a positive electrode substrate exposed portion 15. As shown in FIG. 3B, a negative electrode 12 is produced by the following process: a negative electrode active material mixture is applied onto both sides of a negative electrode substrate of copper foil; the resultant object is dried and extended by applying pressure; and the negative electrode 12 is slit so as to expose the copper foil in a strip along the end of one side in the wide direction. The part of the copper foil exposed in a strip is a negative electrode substrate exposed portion 16.

The width and length of a negative electrode active material mixture layer 12a of the negative electrode 12 are larger than those of a positive electrode active material mixture layer 11a. It is preferable that the positive electrode substrate be formed using foil of aluminum or aluminum alloy having a thickness of about from 10 to 20 μm, while the negative electrode substrate be formed using foil of copper or copper alloy having a thickness of about from 5 to 15 μm. A specific composition of the positive electrode active material mixture layer 11a and the negative electrode active material mixture layer 12a will be described later.

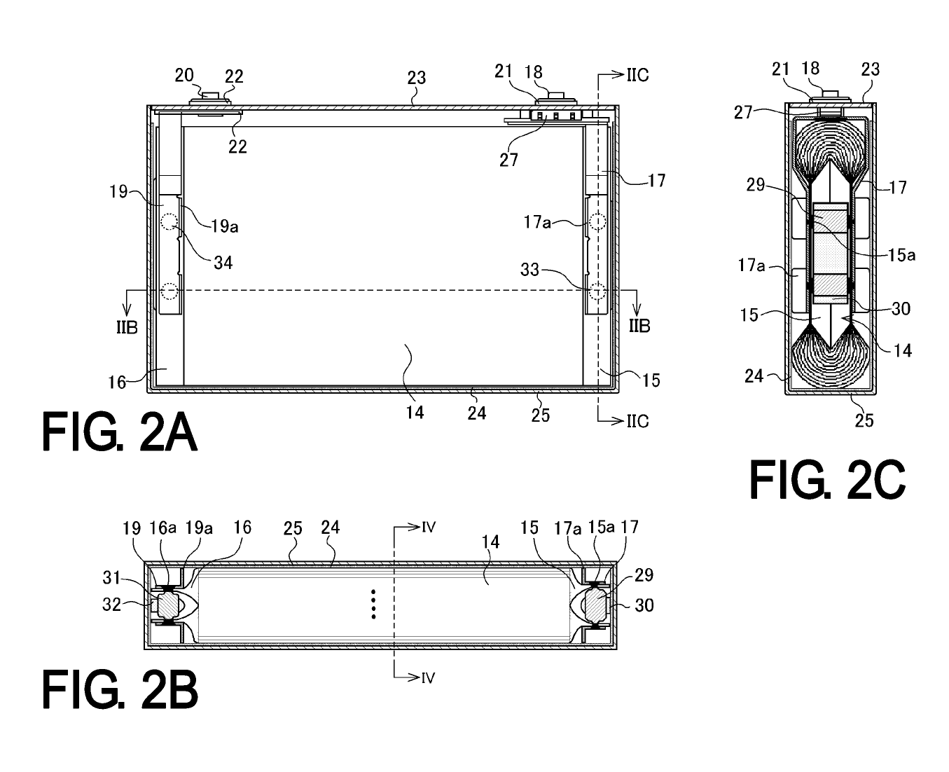

As shown in FIGS. 2A and 2B, a flattened winding electrode assembly 14 having a plurality of stacked layers of the positive electrode substrate exposed portion 15 on one end and a plurality of stacked layers of the negative electrode substrate exposed portion 16 on the other end is produced by the following process: the positive electrode 11 and the negative electrode 12 produced as above are displaced so that the aluminum foil exposed portion of the positive electrode 11 and the copper foil exposed portion of the negative electrode 12 are not overlapped by the active material mixture layers of the opposing electrodes; and the positive electrode 11 and the negative electrode 12 are wound while being insulated from each other with a separator 13 interposed therebetween. A microporous polyolefin membrane is preferably used as the separator 13.

The stacked layers of the positive electrode substrate exposed portion 15 are electrically connected to a positive electrode terminal 18 of aluminum material with a positive electrode collector 17 of aluminum material interposed therebetween. Likewise, the stacked layers of the negative electrode substrate exposed portion 16 are electrically connected to a negative electrode terminal 20 of copper material with a negative electrode collector 19 of copper material interposed therebetween. As shown in FIGS. 1A, 1B, and 2A, the positive electrode terminal 18 and the negative electrode terminal 20 are fixed to a sealing plate 23 of aluminum material or other material with insulating members 21 and 22, respectively, interposed therebetween. Where appropriate, the positive electrode terminal 18 and the negative electrode terminal 20 are connected to an external positive electrode terminal and an external negative electrode terminal (neither shown in the drawings), respectively.

The flat winding electrode assembly 14 produced as above is inserted into a prismatic outer body 25 of aluminum material or other material with one side thereof open with an insulating resin sheet 24 interposed in the periphery except for the sealing plate 23 side. The sealing plate 23 is then fitted to an opening portion of the prismatic outer body 25, and a fitting portion between the sealing plate 23 and the prismatic outer body 25 is laser-welded. Moreover, a nonaqueous electrolyte is poured through an electrolyte pour hole 26, and then the electrolyte pour hole 26 is sealed. Consequently, the nonaqueous electrolyte secondary battery 10 of the embodiment is produced. In the prismatic nonaqueous electrolyte secondary battery 10 of the embodiment, as shown in FIG. 4, starting from the prismatic outer body 25, the resin sheet 24, the separator 13, the negative electrode 12, the separator 13, the positive electrode 11, the separator 13, the negative electrode 12, ′″ are disposed.

A current interruption mechanism 27 operated by a gas pressure generated inside the battery is provided between the positive electrode collector 17 and the positive electrode terminal 18. A gas exhaust valve 28 that is open when a gas pressure higher than the working pressure of the current interruption mechanism 27 is applied is also provided on the sealing plate 23. Therefore, the inside of the nonaqueous electrolyte secondary battery 10 is sealed. The nonaqueous electrolyte secondary battery 10 alone may be used, or a plurality of nonaqueous electrolyte secondary batteries 10 connected in series or in parallel may be used for various purposes. When a plurality of nonaqueous electrolyte secondary batteries 10 connected in series or in parallel are used, the external positive electrode terminal and the external negative electrode terminal may be provided separately to connect the respective batteries with a bus bar.

The flat winding electrode assembly 14 used in the prismatic nonaqueous electrolyte secondary battery 10 of the embodiment is used when high capacity of 20 Ah or more and high output characteristics are required. For example, the number of winding of the positive electrode 11 is 43, in other words, the total number of stacked layers of the positive electrode 11 is 86. When the winding number is 30 or more, in other words, the total number of stacked layers is 60 or more, the capacity of the battery can be 20 Ah or more without increasing the size of the battery beyond necessity.

When the total number of stacked layers of the positive electrode substrate exposed portion 15 or the negative electrode substrate exposed portion 16 is large, a large amount of welding current is needed to form a weld mark 15a or 16a passing through the whole stacked layer portions of the stacked positive electrode substrate exposed portion 15 or the negative electrode substrate exposed portion 16 in resistance-welding the positive electrode collector 17 and the negative electrode collector 19 to the positive electrode substrate exposed portion 15 and the negative electrode substrate exposed portion 16, respectively.

As shown in FIGS. 2A to 2C, in the positive electrode 11, the stacked positive electrode substrate exposed portion 15 is divided into two segments, and a positive electrode intermediate member 30 is interposed therebetween. The positive electrode intermediate member 30 is made of resin material and holds a plurality of positive electrode conductive members 29, here, two positive electrode conductive members 29. Likewise, in the negative electrode 12, the stacked positive electrode substrate exposed portion 16 is divided into two segments, and a negative electrode intermediate member 32 is interposed therebetween. The negative electrode intermediate member 32 is made of resin material and holds two negative electrode conductive members 31. The positive electrode collector 17 is disposed on the surfaces of both sides of the outermost side of the two segments of the positive electrode substrate exposed portion 15 that are disposed on both sides of the positive electrode conductive members 29. The negative electrode collector 19 is disposed on the surfaces of both sides of the outermost side of the two segments of the negative electrode substrate exposed portion 16 that are disposed on both sides of the negative electrode conductive members 31. The positive electrode conductive members 29 are made of aluminum material as with the positive electrode substrate, and the negative electrode conductive members 31 are made of copper material as with the negative electrode substrate. The shape of the positive electrode conductive members 29 and the negative electrode conductive members 31 may be either the same or different.

When the positive electrode substrate exposed portion 15 or the negative electrode substrate exposed portion 16 is divided into two segments, welding current needed to form a weld mark 15a or 16a passing through the whole stacked layer portion of the stacked positive electrode substrate exposed portion 15 or the negative electrode substrate exposed portion 16 is small compared to a case in which there is no division. This prevents sputters during resistance welding, thereby preventing a trouble such as an internal short in the winding electrode assembly 14 due to the sputters. Thus, the resistance welding is performed between the positive electrode collector 17 and the positive electrode substrate exposed portion 15 and between the positive electrode substrate exposed portion 15 and the positive electrode conductive members 29. Resistance welding is also performed between the negative electrode collector 19 and the negative electrode substrate exposed portion 16 and between the negative electrode substrate exposed portion 16 and the negative electrode conductive members 31. FIG. 2 shows two weld marks 33 formed by resistance-welding in the positive electrode collector 17 and two weld marks 34 formed by resistance-welding in the negative electrode collector 19.

The resistance-welding methods with the positive electrode intermediate member 30 including the positive electrode substrate exposed portion 15, the positive electrode collector 17, and the positive electrode conductive members 29, and with the negative electrode intermediate member 32 including the negative electrode substrate exposed portion 16, the negative electrode collector 19, and the negative electrode conductive members 31 in the flat winding electrode assembly 14 of the embodiment will be described in detail below. In the embodiment, the shapes of the positive electrode conductive members 29 and the negative electrode conductive members 31 may be substantially the same, and the shapes of the positive electrode intermediate member 30 and the negative electrode intermediate member 32 may be substantially the same. The resistance-welding methods are substantially the same as well. Therefore, the positive electrode 11 will be described below as an example.

The positive electrode substrate exposed portion 15 of the flat winding electrode assembly 14 produced as above is divided into two segments from the winding central part to both sides and is collected centering on a quarter of the thickness of the electrode assembly. Subsequently, the positive electrode collector 17 is provided on both surfaces on the outermost periphery side of the positive electrode substrate exposed portion 15. On the inner periphery side of the positive electrode substrate exposed portion 15, the positive electrode intermediate member 30 including the positive electrode conductive members 29 is inserted between the two segments of the positive electrode substrate exposed portion 15 so that respective projections on both sides of the positive electrode conductive members 29 are brought into contact with the positive electrode substrate exposed portion 15. For example, the positive electrode collector 17 is made of an aluminum plate that has a thickness of 0.8 mm.

The positive electrode conductive members 29 held by the positive electrode intermediate member 30 of the embodiment have projections that have, for example, a shape of a circular truncated cone and are formed on two surfaces facing each other on the cylindrical main body. As long as the positive electrode conductive members 29 are made of metal and blockish, any shape such as a cylinder, a prism, and an elliptic cylinder may be adopted. Materials made of copper, copper alloy, aluminum, aluminum alloy, tungsten, molybdenum, etc., may be used as a formation material of the positive electrode conductive members 29. Among the materials made of these metals, the following configurations may be adopted: the projection on which nickel plate is applied; and the projection and its base area formed of metal material that facilitates heat generation such as tungsten and molybdenum and, for example, brazed to the main body of the cylindrical positive electrode conductive members 29 made of copper, copper alloy, aluminum or aluminum alloy.

A plurality of, for example, here two pieces of positive electrode conductive members 29 are integrally held by the positive electrode intermediate member 30 made of resin material. In such a case, the respective electrode conductive members 29 are held so as to be in parallel with each other. The positive electrode intermediate member 30 may have any shape such as a prism and cylinder. However, a landscape prism is desirable in order that the positive electrode intermediate member 30 is stably positioned and fixed between the two segments of the positive electrode substrate exposed portion 15. It is preferable that the corners of the positive electrode intermediate member 30 be chamfered in order not to hurt or deform the soft positive electrode substrate exposed portion 15 even if contacting the positive electrode substrate exposed portion 15. At least a part to be inserted between the two segments of the positive electrode substrate exposed portion 15 may be chamfered.

The length of the prismatic positive electrode intermediate member 30 varies depending on the size of the prismatic nonaqueous electrolyte secondary battery 10, but it may be from 20 mm to tens of mm. The width of the prismatic positive electrode intermediate member 30 may be as much as the height of the positive electrode conductive members 29, but at least both ends of the positive electrode conductive members 29 as welded portions may be exposed. It is preferable that both ends of the positive electrode conductive members 29 protrude from the surface of the positive electrode intermediate member 30, but the positive electrode conductive members 29 do not necessarily protrude. Such a structure enables the positive electrode conductive members 29 to be held in the positive electrode intermediate member 30, and the positive electrode intermediate member 30 to be stably positioned and disposed between the two segments of the positive electrode substrate exposed portion 15.

Subsequently, the flat winding electrode assembly 14, which includes the positive electrode collector 17 and the positive electrode intermediate member 30 holding the positive electrode conductive members 29 disposed therein, is arranged between a pair of resistance welding electrodes (not shown in the drawings). The pair of resistance welding electrodes are each brought into contact with the positive electrode collector 17 disposed on both surfaces of the outermost periphery side of the positive electrode substrate exposed portion 15. An appropriate pressure is then applied between the pair of resistance welding electrodes, thereby performing the resistance welding under predetermined certain conditions. In this resistance welding, the positive electrode intermediate member 30 is stably positioned and disposed between the two segments of the positive electrode substrate exposed portion 15, which improves the dimensional accuracy between the positive electrode conductive members 29 and the pair of resistance welding electrodes, enables the resistance welding to be performed in an accurate and stable state, and curbs variation in the welding strength.

Next, the detailed structure of the positive electrode collector 17 and the negative electrode collector 19 of the embodiment will be described with reference to FIG. 2. As shown in FIGS. 2A and 2B, the positive electrode collector 17 is electrically connected to a plurality of layers of the positive electrode substrate exposed portion 15 stacked on one side edge of the flat winding electrode assembly 14 by the resistance welding method. The positive electrode collector 17 is electrically connected to the positive electrode terminal 18. Likewise, the negative electrode collector 19 is electrically connected to a plurality of layers of the negative electrode substrate exposed portion 16 stacked on the other side edge of the flat winding electrode assembly 14 by the resistance welding method. The negative electrode collector 19 is electrically connected to the negative electrode terminal 20.

The positive electrode collector 17 is produced, for example, by punching out an aluminum plate in a particular shape and bending it. The positive electrode collector 17 has a rib 17a formed on its main body part where the resistance welding is performed with a bundle of the positive electrode substrate exposed portion 15. The negative electrode collector 19 is produced, for example, by punching out a copper plate in a particular shape and bending it. The negative electrode collector 19 also has a rib 19a formed on its main body part where the resistance welding is performed with a bundle of the negative electrode substrate exposed portion 16.

The rib 17a of the positive electrode collector 17 and the rib 19a of the negative electrode collector 19 serve as a shield in order to prevent sputters generated during the resistance welding from entering the inside of the flat winding electrode assembly 14, and as a radiation fin in order to prevent a portion other than the resistance welded portion of the positive electrode collector 17 and the negative electrode collector 19 from being melted by heat generated during the resistance welding. The ribs 17a and 19a are provided at a right angle from the main body of the positive electrode collector 17 and the negative electrode collector 19, respectively, but the angle need not necessarily be vertical. Even a tilt of about ±10° from the right angle brings the same function effect.

In the prismatic nonaqueous electrolyte secondary battery 10 of the embodiment, the example shows that two ribs are provided corresponding to the resistance welding position along the longitudinal direction as the rib 17a of the positive electrode collector 17 and the rib 19a of the negative electrode collector 19. However, the configuration is not limited to this case. One rib may be provided, or ribs may be formed on both sides in the width direction. When ribs are formed on both sides in the width direction, their heights may be either the same or different. If their heights are different, it is preferable that the rib around the flat winding electrode assembly 14 be provided at a higher position than the other.

Preparation of Positive Electrode

The following describes a specific composition of the positive electrode active material mixture layer 11a and the negative electrode active material mixture layer 12a and a specific composition of the nonaqueous electrolyte used in the prismatic nonaqueous electrolyte secondary battery 10 of the embodiment. Lithium nickel cobalt manganese composite oxide represented by LiNi_{0.35}Co_{0.35}Mn_{0.30}O₂ was used as the positive electrode active material. This lithium nickel cobalt manganese composite oxide, carbon powder as a conductive agent, and polyvinylidene fluoride (PVdF) as a binding agent were weighed so that the mass ratio would be 88:9:3, and were mixed with N-methyl-2-pyrrolidone (NMP) as dispersion media to produce a positive electrode active material mixture slurry. This positive electrode active material mixture slurry was applied with a die coater onto both sides of the positive electrode substrate of aluminum foil whose thickness was, for example, 15 μm to form the positive electrode active material mixture layer onto both sides of the positive electrode substrate. Next, the resultant object was dried to remove NMP as an organic solvent, and was pressed with a roll press to have a particular thickness. The electrode thus obtained was slit in a particular width on one end of the electrode in the width direction along the whole longitudinal direction to form the positive electrode substrate exposed portion 15 that had no positive electrode active material mixture layer formed onto both sides, and whereby the positive electrode 11 of the structure shown in FIG. 3A was obtained.

In FIG. 3A, when the length of the positive electrode substrate, the width of the positive electrode substrate, the width of the positive electrode active material mixture layer 11a, and the width of the positive electrode substrate exposed portion 15 are Lp, Wp, Wap, and Wcp, respectively, here the following equation holds: Wap=Wp−Wcp. Thus, the area of the positive electrode substrate exposed portions 15 formed onto both sides of the positive electrode 11 is as follows: 2×Wcp×Lp, and 2×Wcp−Lp≧500 cm².

In addition, the following equation holds:

$$( 2 \times Wcp \times Lp ) / ( 2 \times Wap \times Lp ) = Wcp / ( Wp - Wcp ) = 5 to 20 \%$$

In other words, the area (both sides) of the positive electrode substrate exposed portions 15 is 5 to 20% of the area of the positive electrode active material mixture layers 11a formed onto both sides of the positive electrode 11.

Preparation of Negative Electrode

The negative electrode was produced as follows: 98 parts by mass of graphite powder, 1 part by mass of carboxymethylcellulose (CMC) as a thickening agent, and 1 part by mass of styrene-butadiene-rubber (SBR) as a binding agent were dispersed in water to produce a negative electrode active material mixture slurry. This negative electrode active material mixture slurry was applied with a die coater onto both sides of the negative electrode collector of copper foil whose thickness was 10 μm, and was dried to form the negative electrode active material mixture layer onto both sides of the negative electrode collector. Next, the resultant object was pressed with a press roller to have a particular thickness. The electrode thus obtained was slit in a particular width on one end of the electrode in the width direction along the whole longitudinal direction to form the negative electrode substrate exposed portion 16 that had no negative electrode active material mixture layer formed onto both sides, and whereby the negative electrode 12 of the structure shown in FIG. 3B was obtained.

In FIG. 3B, when the length of the negative electrode substrate, the width of the negative electrode substrate, the width of the negative electrode active material mixture layer 12a, and the width of the negative electrode substrate exposed portion 16 are Ln, Wn, Wan, and Wcn, respectively, here the following equation holds: Wan=Wn−Wcn. Thus, the area of the negative electrode substrate exposed portion 16 formed onto both sides of the negative electrode 12 is as follows: 2×Wcn×Ln, and 2×Wcn×Ln≧700 cm².

In addition, the following equation holds:

$$( 2 \times Wcn \times L n ) / ( 2 \times Wan \times L n ) = Wcn / ( Wn - Wcn ) = 5 to 30 \% .$$

In other words, the area (both sides) of the negative electrode substrate exposed portions 16 is 5 to 30% of the area of the negative electrode active material mixture layers 12a formed onto both sides of the negative electrode 12.

Moreover, in the prismatic nonaqueous electrolyte secondary battery 10 of the embodiment, the area of the negative electrode substrate exposed portion 16 is larger than the area of the positive electrode substrate exposed portion 15. In other words, the following equation holds:

2×Wcn×Ln>2×Wcp×Lp.

Preparation of Nonaqueous Electrolyte

The nonaqueous electrolyte to be used was produced as follows: as a solvent, ethylene carbonate (EC) and methyl ethyl carbonate (MEC) were mixed with a volume ratio (25° C. and 1 atmosphere) of 3:7; LiPF₆ as an electrolyte salt was added to the mixed solvent so that the concentration would be 1 mol/L; and then LiBOB as a lithium salt having an oxalate complex as an anion was further added so that the concentration would be 0.1 mol/L. The added LiBOB is reacted on the surface of the negative electrode at the initial charge to form a protective covering. Therefore, in the prismatic nonaqueous electrolyte secondary battery 10 of the embodiment, all LiBOB added to the nonaqueous electrolyte is not necessarily present in the form of LiBOB.

Production of Prismatic Nonaqueous Electrolyte Secondary Battery

The negative electrode 12 and the positive electrode 11 produced as above were wound while being insulated from each other with the separator 13 interposed therebetween so as to dispose the negative electrode 12 onto the outermost periphery side. Subsequently, the resultant object was formed to be flat, and whereby the flat winding electrode assembly 14 was produced. In the flat winding electrode assembly 14, the winding numbers of the positive electrode 11 and the negative electrode 12 were 43 and 44, respectively, in other words, the numbers of stacked layers of the positive electrode 11 and the negative electrode 12 were 86 and 88, respectively, and the design capacity was 20 Ah. Furthermore, the total numbers of stacked layers of the positive electrode substrate exposed portion 15 and the negative electrode substrate exposed portion 16 were 86 and 88, respectively. The area (both sides) of the negative electrode substrate exposed portions 16 of the flat winding electrode assembly 14 is 700 cm², and the area (both sides) of the positive electrode substrate exposed portions 15 is 500 cm². This flat winding electrode assembly 14 was used to produce a prismatic nonaqueous electrolyte secondary battery without the nonaqueous electrolyte poured. Subsequently, the prismatic outer body 25 was vacuum-degassed, a particular amount of the nonaqueous electrolyte produced as above was poured through an electrolyte pour hole 26 provided to the sealing plate 23, and the electrolyte pour hole 26 was then sealed with a blind rivet, thereby preparing the prismatic nonaqueous electrolyte secondary battery 10 of the embodiment that has the structure shown in FIGS. 1 and 2. It is preferable that a pre-charge be performed after pouring the nonaqueous electrolyte and before sealing the electrolyte pour hole 26.

In the prismatic nonaqueous electrolyte secondary battery 10 of the embodiment, the nonaqueous electrolyte containing LiBOB is used, thereby providing the nonaqueous electrolyte secondary battery having excellent cycling characteristics. The area of the negative electrode substrate exposed portion 16 of the flat winding electrode assembly 14 is 700 cm², and the area of the positive electrode substrate exposed portion 15 is 500 cm², thereby improving heat release characteristics from the inside of the electrode assembly, preventing an increase in temperature of the negative electrode, and preventing a reaction between the negative electrode where the protective covering derived from LiBOB is formed and the nonaqueous electrolyte. Furthermore, the area of the negative electrode substrate exposed portion is larger than the area of the positive electrode substrate exposed portion, thereby preventing an increase in temperature of the negative electrode and preventing a react ion between the negative electrode where the protective covering is formed and the nonaqueous electrolyte more efficiently.

In the prismatic nonaqueous electrolyte secondary battery 10 of the above-mentioned embodiment, an example of adding LiBOB to the nonaqueous electrolyte as an additive is shown. However, in the present invention, as the lithium salt having an oxalate complex as an anion, lithium difluoro(oxalato)borate, lithium tris(oxalato)phosphate, lithium difluoro(bisoxalato)phosphate, and lithium terafluoro(oxalato)phosphate, for example, may be used.

In addition, for example, LiPF₂O₂ may be included other than a lithium salt having an oxalate complex as an anion. When LiPF₂O₂ is contained in the nonaqueous electrolyte as an additive, it reacts with lithium at the charge and discharge to form a high-quality protective covering on the surface of the positive electrode and the negative electrode. This protective covering prevents a direct reaction between an active material in a state of charge and an organic solvent, thereby preventing a decomposition of the nonaqueous electrolyte and obtaining the nonaqueous electrolyte secondary battery that has excellent charge storage characteristics.

First Modification

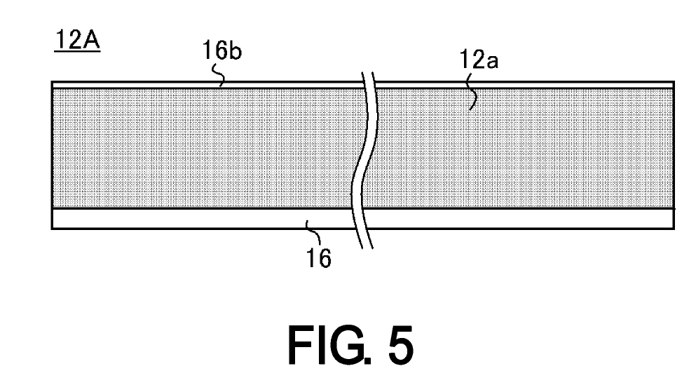

A negative electrode 12A of a first modification has a larger area than the negative electrode 12 of the embodiment, and has negative electrode substrate exposed portions 16 and 16b formed in a particular width onto both ends in the width direction (lateral direction) as shown in FIG. 5. The negative electrode substrate exposed portion 16b is formed on both sides of the negative electrode 12. This allows an area of a part where a negative electrode active material mixture layer 12a of the negative electrode 12A is formed to be the same as that of a part where the negative electrode active material mixture layer 12a of the negative electrode 12 is formed in the embodiment, and also enlarges the area of the negative electrode 12 for an additionally created negative electrode substrate exposed portion 16b. The positive electrode 11 is used that has the same size and the same structure as the positive electrode 11 of the embodiment shown in FIG. 3A.

Using the negative electrode 12A in such a structure can enlarge the area of the negative electrode substrate exposed portion 16b, thereby improving the heat release efficiency of the negative electrode 12A. It is preferable that the separators 13 be interposed on both sides of the additionally created negative electrode substrate exposed portion 16b of the negative electrode 12A.

Second Modification

In the nonaqueous electrolyte secondary battery 10 of the above-mentioned embodiment, an example is shown where each of the stacked layers of the positive electrode substrate exposed portion 15 and the stacked layers of the negative electrode substrate exposed portion 16 are divided into two segments, and the positive electrode intermediate member 30 including the positive electrode conductive members 29 and the negative electrode intermediate member 32 including the negative electrode conductive member 31 are interposed therebetween. However, in the present invention, the stacked layers of the positive electrode substrate exposed portion 15 or the negative electrode substrate exposed portion 16 may not be divided into two segments.

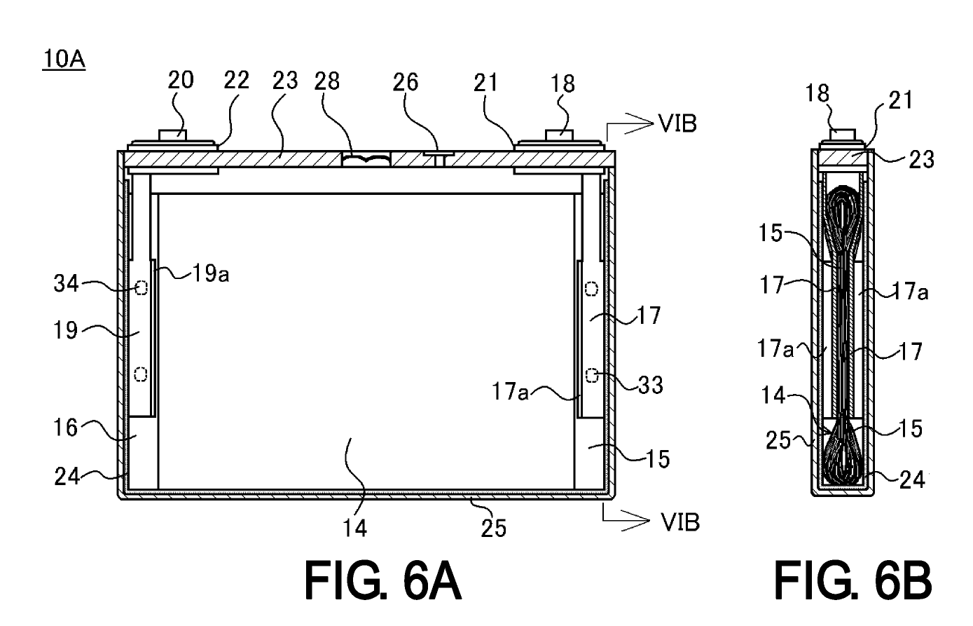

A prismatic nonaqueous electrolyte secondary battery 10A in accordance with a second modification will be described with reference to FIG. 6. In the second modification, neither of the stacked layers of the positive electrode substrate exposed portion 15 nor the negative electrode substrate exposed portion 16 is divided into two segments, and no positive electrode conductive member or negative electrode conductive member is used. In FIG. 6, the same numbers are given to the same components corresponding to the prismatic nonaqueous electrolyte secondary battery 10 of the embodiment shown in FIG. 2, and the detailed description thereof is omitted. In the flat winding electrode assembly 14 of the second modification, a resistance welded portion between the positive electrode substrate exposed portion 15 and the positive electrode collector 17 and a resistance welded portion between the negative electrode substrate exposed portion 16 and the negative electrode collector 19 have substantially similar structures except for the difference of respective formation materials. Thus, FIG. 6B shows a side view of the positive electrode substrate exposed portion 15 as an example, and a side view of the negative electrode substrate exposed portion 16 is not shown.

In the flat winding electrode assembly 14 used in the prismatic nonaqueous electrolyte secondary battery 10A of the second modification, the amount of the positive electrode active material mixture layer 11a of the positive electrode 11 and the negative electrode active material mixture layer 12a of the negative electrode 12 per unit area are larger than in the embodiment. In addition, the winding numbers of the positive electrode 11 and the negative electrode 12 are 35 and 36, respectively, in other words, the numbers of stacked layers of the positive electrode 11 and the negative electrode 12 are 70 and 72, respectively, and the design capacity is 25 Ah. Furthermore, the total numbers of stacked layers of the positive electrode substrate exposed portion 15 and the negative electrode substrate exposed portion 16 are 70 and 72, respectively. On the positive electrode 11, the positive electrode collector 17 is disposed on the surfaces of both sides of the outermost side of the stacked layers of the positive electrode substrate exposed portion 15, while on the negative electrode 12 side, the negative electrode collector 19 is disposed on the surfaces of both sides of the outermost side of the stacked layers of the negative electrode substrate exposed portion 16. The resistance welding is performed at two points so that weld marks (not shown in the drawings) are formed so as to pass through the whole stacked layer portions of the bundle of the positive electrode substrate exposed portion 15 or the negative electrode substrate exposed portion 16.

In the flat winding electrode assembly 14 used in the prismatic nonaqueous electrolyte secondary battery 10A of the second modification, one rib formed across the resistance welding points is used as the rib 17a formed onto the positive electrode collector 17 and the rib 19a formed onto the negative electrode collector 19.

The prismatic nonaqueous electrolyte secondary battery of the above-mentioned embodiment, the first modification, and the second modification shows an example of connecting between the positive electrode substrate exposed portion 15 and the positive electrode collector 17 and between the negative electrode substrate exposed portion 16 and the negative electrode collector 19 by resistance-welding, but the connection can be made by ultrasonic welding or irradiation of high-energy rays such as a laser. Furthermore, different connections may be made on the positive electrode side and the negative electrode side.

1. A nonaqueous electrolyte secondary battery comprising:
a flat winding electrode assembly formed by winding an elongated positive electrode and an elongated negative electrode with an elongated separator interposed therebetween; and
a prismatic outer body storing the flat winding electrode assembly and a nonaqueous electrolyte,
the positive electrode including a positive electrode substrate exposed portion formed along a longitudinal direction,
the negative electrode including a negative electrode substrate exposed portion formed along a longitudinal direction,
the nonaqueous electrolyte containing a lithium salt having an oxalate complex as an anion at the time of making the nonaqueous electrolyte secondary battery,
the area of the negative electrode substrate exposed portion being 700 cm² or more,
the area of the positive electrode substrate exposed portion being 500 cm² or more, and
the area of the negative electrode substrate exposed portion being larger than the area of the positive electrode substrate exposed portion.

2. The nonaqueous electrolyte secondary battery according to claim 1, wherein
the area of the negative electrode substrate exposed portion is 5 to 30% of the area of negative electrode active material mixture layers formed onto both sides of the negative electrode, and the area of the positive electrode substrate exposed portion is 5 to 20% of the area of positive electrode active material mixture layers formed onto both sides of the positive electrode.

3. The nonaqueous electrolyte secondary battery according to claim 1, wherein
the flat winding electrode assembly includes the positive electrode substrate exposed portion wound on one end and the negative electrode substrate exposed portion wound on the other end,
both outer faces of the wound positive electrode substrate exposed portion are welded and connected to a positive electrode collector, and
both outer faces of the wound negative electrode substrate exposed portion are welded and connected to a negative electrode collector.

4. The nonaqueous electrolyte secondary battery according to claim 1, wherein
the negative electrode substrate exposed portion is formed on both ends of the negative electrode in a width direction along the longitudinal direction.

5. The nonaqueous electrolyte secondary battery according to claim 4, wherein
one of the negative electrode substrate exposed portions is wider than the other, and the wider substrate exposed portion is connected to the negative electrode collector.

6. The nonaqueous electrolyte secondary battery according to claim 1, wherein
the positive electrode substrate exposed portion is formed only on one side of the positive electrode in a width direction along the longitudinal direction.

7. The nonaqueous electrolyte secondary battery according to claim 1, wherein
the battery capacity is 4 Ah or more.

8. The nonaqueous electrolyte secondary battery according to claim 1, wherein
the nonaqueous electrolyte contains lithium difluorophosphate (LiPF₂O₂) at the time of making the nonaqueous electrolyte secondary battery.

9. The nonaqueous electrolyte secondary battery according to claim 1, wherein
the lithium salt having the oxalate complex as an anion is lithium bis(oxalato)borate (Li[B(C₂O₄)₂]).

10. The nonaqueous electrolyte secondary battery according to claim 1, wherein,
the nonaqueous electrolyte contains a lithium salt having an oxalate complex as an anion.

11. The nonaqueous electrolyte secondary battery according to claim 8, wherein
the nonaqueous electrolyte contains lithium difluorophosphate (LiPF₂O₂)
